(19) United States
(12) Patent Application Publication
(10) Pub. No.: US 2026/0220739 A1
(43) Pub. Date: Jul. 30, 2026

(54) HIGH-RESOLUTION IMAGE RECONSTRUCTION

(71) Applicant: INTERNATIONAL BUSINESS MACHINES CORPORATION, Armonk, NY (US)

(72) Inventors: Kyong Min YEO, Scarsdale, NY (US); Takuya KURIHANA, Farragut, TN (US); Levente KLEIN, Tuckahoe, NY (US); Daniela DE MATTOS SZWARCMAN, Rio de Janeiro (BR)

(21) Appl. No.: 19/039,267

(22) Filed: Jan. 28, 2025

(51) Int. Cl. G06T 3/4053; G06T 3/4046

(52) U.S. Cl. CPC G06T 3/4053; G06T 3/4046

(57) ABSTRACT

Computer implemented methods, systems, and computer program products include program code executing on a processor(s) which obtains low-resolution data comprising the low-resolution image. The program code applies, to the low-resolution data, a two-dimensional convolutional filter. In applying the filter the program code automatically learns a spatial structure of the low-resolution data, generates a representation of the spatial structure of the low-resolution data, transforms physical space information to model-space information, replicates the representation to generate additional representations that coordinate with vectors, and generates a self-attention map by calculating a dot product between certain of the additional representations to learn vertical mixing of information. The program code applies a penalty term to the self-attention map to amplify strong signals and reduce weak signals.

### BACKGROUND

One or more aspects relate, in general, to digital image compression and transmission, and, in particular, to reconstructing high-resolution images based on low-resolution images.

High-resolution images are utilized in various applications where the details and granular data provided are particularly useful. For example, high-resolution weather simulation data, which can include high-resolution images is used in agriculture, power generation prediction and location selection, and in greenhouse gas emission estimation.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Neural networks (NN) refer to a biologically inspired programming paradigm which enables a computer to learn from observational data. This learning is referred to as deep learning, which is a set of techniques for learning in neural networks. Neural networks, including modular neural networks, are capable of pattern recognition with speed, accuracy, and efficiency, in situations where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in image recognition, speech recognition, and natural language processing (NLP). Neural networks can model complex relationships between inputs and outputs to identify patterns in data, including in images, for classification.

A convolutional neural network (CNN) is a class of neural network. CNNs utilize feed-forward artificial neural networks and are most commonly applied to analyzing visual imagery. CNNs are so named because they utilize convolutional layers that apply a convolution operation (a mathematical operation on two functions to produce a third function that expresses how the shape of one is modified by the other) to the input, passing the result to the next layer. The convolution emulates the response of an individual neuron to visual stimuli. Each convolutional neuron processes data only for its receptive field. It is not practical to utilize general (i.e., fully connected feedforward) neural networks to process images, as very high number of neurons would be necessary, due to the very large input sizes associated with images. Utilizing a CNN addresses this issue as it reduces the number of free parameters, allowing the network to be deeper with fewer parameters, as regardless of image size, the CNN can utilize a consistent number of learnable parameters because CNNs fine-tune large amounts of parameters and massive pre-labeled datasets to support a learning process. CNNs resolve the vanishing or exploding gradients problem in training traditional multi-layer neural networks, with many layers, by using backpropagation. Thus, CNNs can be utilized in large-scale (image) recognition systems, giving state-of-the-art results in segmentation, object detection and object retrieval. CNNs can be of any number of dimensions, but most existing CNNs are two-dimensional and process single images. These images contain pixels in a two-dimensional (2D) space (length, width) that are processed through a set of two-dimensional filters to understand what set of pixels best correspond to the final output classification. A three-dimensional CNN (3D-CNN) is an extension of the more traditional two-dimensional CNN and a 3D-CNN is typically used in problems related to video classification. 3D-CNNs accept multiple images, often sequential image frames of a video, and use 3D filters to understand the 3D set of pixels that are presented to it. In the present context, as discussed herein, images provided to a CNN include images of a culture, including but not limited to, stain images of a culture.

As classifier is comprised of various cognitive algorithms, AI instruction sets, and/or machine learning algorithms. Classifiers can include, but are not limited to, deep learning models (e.g., neural networks having many layers) and random forests models. Classifiers classify items (data, metadata, objects, etc.) into groups, based on relationships between data elements in the metadata from the records. In some embodiments of the present invention, the program code can utilize the frequency of occurrences of features in mutual information to identify and filter out false positives. In general, program code utilizes a classifier to create a boundary between data of a first quality data of a second quality. As a classifier is continuously utilized, its accuracy can increase as testing the classifier tunes its accuracy. When training a classifier, in some examples, program code feeds a pre-existing feature set describing features of metadata and/or data into the one or more cognitive analysis algorithms that are being trained. The program code trains the classifier to classify records based on the presence or absence of a given condition, which is known before the tuning. The presence or absence of the condition is not noted explicitly in the records of the data set. When classifying a source as providing data of a given condition (based on the metadata), utilizing the classifier, the program code can indicate a probability of a given condition with a rating on a scale, for example, between 0 and 1, where 1 would indicate a definitive presence. The classifications need not be binary and can also be values in an established scale.

A deep learning model refers to a type of classifier. A deep learning model can be implemented in various forms such as by a neural network (e.g., a convolutional neural network). In some examples, a deep learning mode includes multiple layers, each layer comprising multiple processing nodes. In some examples, the layers process in sequence, with nodes of layers closer to the model input layer processing before nodes of layers closer to the model output. Thus, layers feed to the next. Interior nodes are often “hidden” in the sense that their input and output values are not visible outside the model.

### SUMMARY

Shortcomings of the prior art are overcome, and additional advantages are provided through the provision of a computer-implemented method for reconstructing a high-resolution image from a low-resolution image. The method can include: obtaining, by one or more processors, low-resolution data comprising the low-resolution image; applying, by the one or more processors, to the low-resolution data, a two-dimensional convolutional filter, wherein the applying comprises: automatically learning, by the one or more processors, a spatial structure of the low-resolution data; generating, by the one or more processors, a representation of the spatial structure of the low-resolution data; transforming, by the one or more processors, physical space information to model-space information; replicating, by the one or more processors, the representation to generate additional representations that coordinate with vectors; and generating, by the one or more processors, a self-attention map by calculating a dot product between certain of the additional representations to learn vertical mixing of information; and applying, by the one or more processors, a penalty term to the self-attention map, wherein the applying modified data comprising the self-attention map by amplifying strong signals and reducing weak signals.

Shortcomings of the prior art are overcome, and additional advantages are provided through the provision of a computer program product for reconstructing a high-resolution image from a low-resolution image. The computer program product comprises a storage medium readable by a one or more processors and storing instructions for execution by the one or more processors for performing a method. The method includes, for instance: obtaining, by the one or more processors, low-resolution data comprising the low-resolution image; applying, by the one or more processors, to the low-resolution data, a two-dimensional convolutional filter, wherein the applying comprises: automatically learning, by the one or more processors, a spatial structure of the low-resolution data; generating, by the one or more processors, a representation of the spatial structure of the low-resolution data; transforming, by the one or more processors, physical space information to model-space information; replicating, by the one or more processors, the representation to generate additional representations that coordinate with vectors; and generating, by the one or more processors, a self-attention map by calculating a dot product between certain of the additional representations to learn vertical mixing of information; and applying, by the one or more processors, a penalty term to the self-attention map, wherein the applying modified data comprising the self-attention map by amplifying strong signals and reducing weak signals.

Shortcomings of the prior art are overcome, and additional advantages are provided through the provision of a system for reconstructing a high-resolution image from a low-resolution image. The system includes: a memory, one or more processors in communication with the memory, and program instructions executable by the one or more processors via the memory to perform a method. The method can include obtaining, by the one or more processors, low-resolution data comprising the low-resolution image; applying, by the one or more processors, to the low-resolution data, a two-dimensional convolutional filter, wherein the applying comprises: automatically learning, by the one or more processors, a spatial structure of the low-resolution data; generating, by the one or more processors, a representation of the spatial structure of the low-resolution data; transforming, by the one or more processors, physical space information to model-space information; replicating, by the one or more processors, the representation to generate additional representations that coordinate with vectors; and generating, by the one or more processors, a self-attention map by calculating a dot product between certain of the additional representations to learn vertical mixing of information; and applying, by the one or more processors, a penalty term to the self-attention map, wherein the applying modified data comprising the self-attention map by amplifying strong signals and reducing weak signals.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is a depiction of variance in wind conditions over time in a physical environment, which is accounted for in the image reconstruction described in the present disclosure;

FIG. 3 is a workflow that illustrates various aspects of image reconstruction performed by program code in the present disclosure;

FIG. 4 illustrates a representation of image data generated by program code in the present disclosure;

FIG. 5 illustrates a representation of image data generated by program code in the present disclosure;

FIG. 6 illustrates various aspects of the image reconstruction performed by program code in the present disclosure;

FIG. 7 illustrates a representation of image data generated by program code in the present disclosure;

FIG. 8 is an illustration contrasting a kernel of a convolutional neural network with a Weather Research and Forecasting model;

FIG. 9 is a workflow that illustrates various aspects of image reconstruction performed by program code in the present disclosure;

FIG. 10 provides additional illustrations relevant to certain aspects of FIGS. 3 and 9.

### DETAILED DESCRIPTION

The computer-implemented methods, computer program products, and systems described herein comprise program code executing on one or more processors that can reconstruct a high-resolution image from a low-resolution image. The program code obtains a low-resolution image at a neural network, where some of these data can be inhomogeneous along a vertical vector. In a non-limiting example where the low-resolution image comprises wind weather data as, these data can be inhomogeneous along the vertical vector. The program code derives a digital map representing pixel layers from the data. The program code identifies and/or captures patterns, relationships, and/or associations in adjacent vertical pixel layers of the digital map. The program code derives a self-attention matrix derived from the digital map and applies a self-attention mechanism to amplify and reduce signal of the self-attention matrix derived from the digital map. As part of applying the self-attention mechanism, the program code can calculate a dot product to transform physical space information into model-space information. The program code, in some examples, can then optimize the digital map using a loss function. Utilizing the optimized digital map, the program code generates a high-resolution digital model, which is a high-resolution image (e.g., an original high-resolution image from which the low-resolution image originated).

As noted above, in some examples, the program code applies a self-attention mechanism or technique. Self-attention is a mechanism used in machine learning, particularly in NLP and computer vision tasks, to capture dependencies and relationships within input sequences. By applying self-attention, program code can identify and weigh the importance of different parts of the input sequence (e.g., by attending to itself). A self-attention mechanism transforms an input sequence into three vectors: query, key, and value by linearly transforming the input. The program code of the attention mechanism calculates a weighted sum of the values based on the similarity between a query and key vectors to generate a weighted sum. This mechanism passes the weighted sum and the original input through a feed-forward neural network to produce a final output. Self-attention enables a machine learning model to focus on relevant information and capture long-range dependencies.

The utilization of self-attention provides various benefits which are advantageous in the examples herein. For example, program code can utilize self-attention to identify long-range dependencies; self-attention allows a machine learning model to capture relationships between distant elements in a sequence, enabling the model to understand complex patterns and dependencies. Program code can also utilize self-attention for contextual understanding meaning that by attending to different parts of the input sequence, program code can utilize self-attention to help a model understand a context and assign appropriate weights to each element based on its relevance. Self-attention is also computationally efficient and scalable for large datasets because self-attention can be computed in parallel for each element in a sequence.

The examples herein are inextricably tied to computing and, as aforementioned, directed to a practical purpose. A practical application is reconstructing a high-resolution (HR) image from a low-resolution image. Although HR data are essential in many problems, it is too computationally intensive to solve a 3-D physics model for an operation purpose. The examples herein address this issue by generating a deep learning model that generates HR images from a low-resolution input data. This is a practical application as well as being inextricably tied to computing because the described HR image issue us a challenge in computing.

The examples herein are inextricably tied to computing at least because the examples herein build a deep learning emulator that reduces the computational costs, hence, improving the computing systems as a whole. The examples herein enable the generation of HR images from low-resolution data, which reduces computing costs and improves efficiencies within the computing system as a whole.

The examples provide significantly more than existing methods for reconstructing HR images from low-resolution (LR) images because HR, although essential to many challenges, are too computationally intensive to solve a 3-D physics model for an operation purpose. Thus, existing approaches cannot be utilized for the practical applications described herein. The examples herein includes a deep learning model that generates such HR images from a LR input data, such that it can be used as a surrogate model. Thus, the approach described herein is less computationally intense but still generates quality results.

Neural networks, which are utilized in certain of the examples herein, refer to a biologically inspired programming paradigm which enables a computer to learn from observational data. This learning is referred to as deep learning, which is a set of techniques for learning in neural networks. Neural networks, including modular neural networks, are capable of pattern recognition with speed, accuracy, and efficiency, in situations where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in image recognition, speech recognition, and natural language processing. Neural networks can model complex relationships between inputs and outputs to identify patterns in data, including in images, for classification. For this reason, machine learning models in the examples herein can utilize neural networks to generate self-healing logs.

In certain embodiments of the present invention the program code utilizes a CNN. CNNs are so named because they utilize convolutional layers that apply a convolution operation (a mathematical operation on two functions to produce a third function that expresses how the shape of one is modified by the other) to the input, passing the result to the next layer. The convolution emulates the response of an individual neuron to visual stimuli. Each convolutional neuron processes data only for its receptive field. It is generally not practical to utilize general (i.e., fully connected feedforward) neural networks to process data rich objects, as very high number of neurons would be necessary, due to the very large input sizes associated with larger files. Utilizing a CNN addresses this issue as it reduces the number of free parameters, allowing the network to be deeper with fewer parameters, as regardless of the file size, the CNN can utilize a consistent number of learnable parameters because CNNs fine-tune large amounts of parameters and massive pre-labeled datasets to support a learning process. CNNs resolve the vanishing or exploding gradients problem in training traditional multi-layer neural networks, with many layers, by using backpropagation. Thus, CNNs can be utilized in large-scale recognition systems, giving state-of-the-art results in segmentation, object detection, and object retrieval. Semantic recognition is an example of large-scale recognition in which a CNN can be utilized by the program code.

In certain embodiments of the present invention the program code utilizes an RNN. An RNN is a class of NN where connections between units form a directed cycle to exhibit dynamic temporal behavior. Unlike feedforward NNs, RNNs can use their internal memory to process arbitrary sequences of inputs. For this reason, current applications of RNNs include unsegmented data recognition, connected handwriting recognition, and speech recognition. Given that LLMs can receive speech as well as natural language in other formats (e.g., text), including via a chatbot, an RNN can be utilized in various examples herein. RNNs can also be utilized to analyze logs, which can have a specialized language or pattern.

The examples herein include a computer-implemented method, a computer program product, and a computer system for reconstructing a high-resolution image from a low-resolution image. In certain of the examples herein, program code executing on one or more processors obtains low-resolution data comprising the low-resolution image. The program code applies to the low-resolution data, a two-dimensional convolutional filter. The applying includes the program code automatically learning a spatial structure of the low-resolution data, generating a representation of the spatial structure of the low-resolution data, transforming physical space information to model-space information, replicating the representation to generate additional representations that coordinate with vectors; and generating a self-attention map by calculating a dot product between certain of the additional representations to learn vertical mixing of information. In some examples, the program code applies a penalty term to the self-attention map, wherein the applying modified data comprising the self-attention map by amplifying strong signals and reducing weak signals.

In some examples, the program code applies a neural network to the self-attention map to generate the high-resolution image by utilizing the additional representations and the self-attention map.

In some examples, the additional representations comprise a first representation, a second representation, and a third representation based on replicating the representation three times based on three vectors.

In some examples, dot product comprises a product of the first representation and the second representation.

In some examples, the three vectors comprise a query (Q) vector, a key (K) vector, and a value (V) vector.

In some examples, the first representation comprises a query (Q) representation, and the second representation comprises a key (K) representation.

In some examples, the program code applying the two-dimensional convolutional filter and replicating the representation comprises generating a layered representation of the low-resolution data.

In some examples, each layer of the layered representation of the low-resolution data comprises a layer of a given height.

In some examples, the given height is selected from the group consisting of: a pre-defined height or a height selected based on an expected outcome to capture dynamics.

In some examples, transforming the physical space information to model-space information to applying a self-attention model at each pixel of the layered representation.

In some examples, the program code learns dynamics in a vertical direction from the layered representation.

In some examples, the neural network is a trained neural network.

In some examples, the program code trains the neural network, wherein the training comprises minimizing a loss function to regularize behavior of the neural network.

In some examples, the high-resolution image comprises a super-resolution image.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

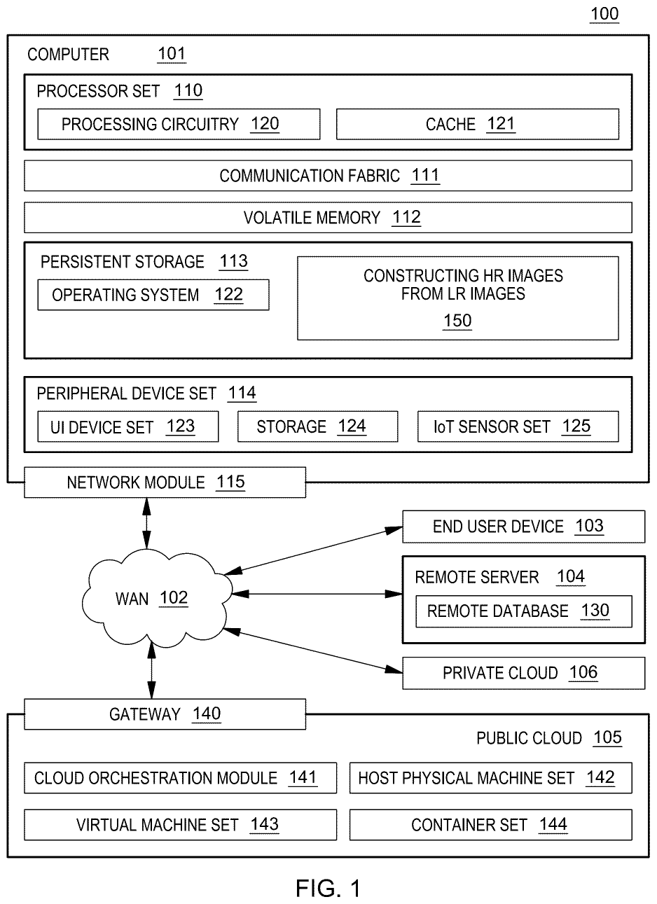

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for reconstructing HR images from LR images 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The examples herein include computer-implemented methods, computer program products, and computer systems where program code executing on one or more processors reconstructs three dimensional HR images from LR images by utilizing machine learning and specifically, learning an inhomogeneous physics condition. The examples herein also address a perceived shortcoming in the use of CNNs wherein CNNs can fall short in capturing physics (realities of the physical world), because a CNN traditionally utilizes a homogenous filter while a physics system can be inhomogeneous. HR data are utilized in various problems and models but handling HR data can be computationally intensive and it is can specifically be too resource intensive to solve a 3-D physics model for an operation purpose. Thus, the examples herein comprise a deep learning model that generates such HR image from LR input data such that the result can be used as a surrogate model.

One example of an application of the aspects herein is utilizing this type of image processing in high-resolution weather simulations as these simulations, when generating using traditional approaches, utilize extensive computational resources. This particular example is referenced throughout for illustrative purposes only and not to suggest any limitations to applications of the aspects of the examples herein. To that end, HR weather simulation data are used in agriculture, power generation prediction/location selection, and in greenhouse gas emission estimation. Using present methods of weather simulation, one can generate a three-dimensional grid system, where one can decompose winds into U, V, W for eastward/southward/vertical directions, and one can calculate wind and other values at every grid. For higher and higher the spatial resolutions of model, more and more computational resources are required. The examples herein comprise a deep learning emulator that can be applied to this and other challenges to generate results and to reduce the computational costs.

There are specific challenges in applying a CNN that translate to the weather-based examples explained above. First, CNNs, which typically use a fixed kernel, only learn a fixed relation from the data but 3D dynamics in a weather system can change during the day and night, vertically. A non-limiting example of a kernel can be 3×3×3, however, this example is provided for illustrative purposes only and not to suggest any limitations. Second, the configuration of a CNN is somewhat incompatible with a widely used weather simulation, called Weather Research and Forecasting (WRF).

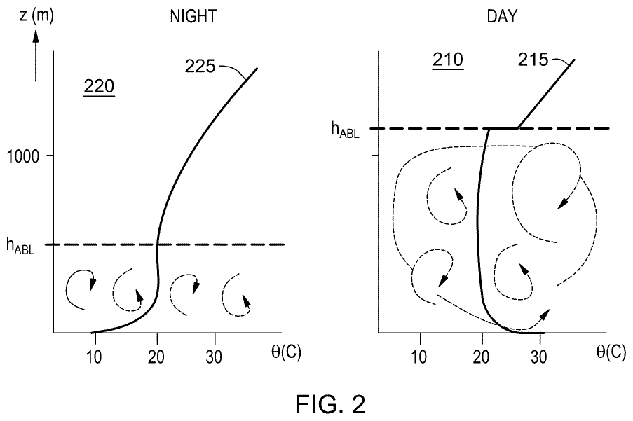

CNNs, which typically use a fixed kernel, only learn a fixed relation from the data but 3D dynamics in a weather system can change during the day and night, vertically. This variation can occur because the atmospheric boundary has a more energetic mixing near the ground than the upper atmosphere. Also, the height of the mixing layers changes with a diurnal cycle. FIG. 2 illustrates a vertical convention during the day 210 and during the night 220. The potential temperature during the day 215 and the potential temperature during the night 225 are labeled. Theta is a key variable to determine a level of convection at lower atmosphere, i.e., when difference of potential temperature θ between high and low altitudes is small, turbulence is formed. FIG. 2 demonstrates that when the surface is heated in daytime, more mixing happens and during nighttime, the opposite occurs, and mixing is suppressed. As a result, the relation between the data points changes with the diurnal cycle. However, a conventional CNN utilizing a fixed kernel will fall short in capturing these changes in the dynamics.

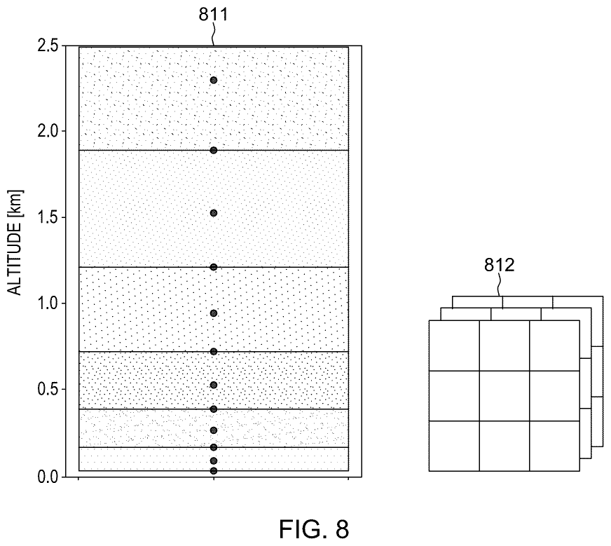

A CNN's fixed kernel is suboptimal to learn information from WRF simulation data due to the non-uniform vertical grid system. WRF is widely used and uses non-uniform grid in vertical axis for computational stability. WRF adjusts each vertical layer as the difference between adjacent layers becomes larger at higher altitude. CNN's fixed kernel does not capture physics due to the changes in the spacing between the layers. FIG. 8 illustrates differences between an WRF model a kernel (in this example, for illustrative purposes only, 3×3×3) of a CNN to show how a WRF model 811 utilizes a non-uniform grid in a vertical axis for computational stability. The WRF 811 illustration represents a height of each layer with dots. As the altitude increases, the difference between adjacent layers becomes larger. The CNN kernel 812 does not capture physics at same vertical scaling as distances are fixed.

The examples herein include computer-implemented methods, computer program products, and computer systems where program code executing on one or more processors reconstructs an HR image from an LR image. Various aspects can include generating a 3D super resolution model that learns the inhomogeneous physics from the data. The program code can also combine a 2D homogeneous filter and a 1D attention network to learn physics from data. The program code can also execute a regularization technique to impose a sparsity on the attention map to focus more on the physics. The physics described the physical conditions which can be learned and modeled by the program code herein.

The examples herein integrate pixel-wise self-attention into a self-learning network. The program code generates super-resolution network “f” to resolve coarse resolution images to high-resolution image by upscaling. In some examples, the program code of the generated network upscales a predetermined or fixed number of times. In some examples, the number of times is nine but this values is provided as a non-limiting example for illustrative purposes only. The program code of the generated network converts super resolved wind data to high-resolution data and learns vertical dynamics from each pixel of the data. The program code also applies a self-attention module “g” at each pixel in horizontal scale. The program code of the model generated (e.g., trained and utilized) in the examples herein converts input data from physical space to a model space, and then learn dynamics in a vertical direction from the data. The network ƒ enables to super-resolve wind data (Low Reso: LR→High Reso: HR), while the program code learns vertical dynamics from each pixel via g.

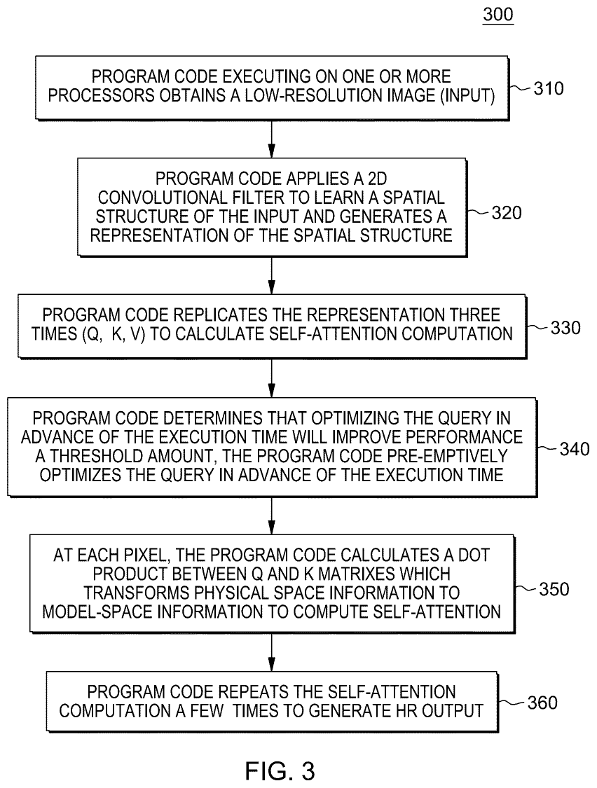

FIG. 3 is a workflow 300 that illustrates various aspects of some examples herein. This workflow illustrates program code comprising a model reconstructing an HR image from an LR image. As part of the workflow 300, which is described below, the program code receives wind weather data as an LR image at a neural network (the wind weather data is inhomogeneous along a vertical vector). The program code captures associations among adjacent vertical layers of a digital map representing pixel layers derived from the wind weather data. The program code derived a self-attention matrix and the program code applies a technique to amplify and reduce signals of the self attention matrix derived from the digital map. At each pixel, the program code calculates a dot product which transforms physical space information to model-space information. The program code optimizes the digital map using a loss function. The program code generates a high-resolution digital image using the optimized digital map.

Specifically, FIG. 3 illustrates various aspects of the model architecture in which program code can reconstruct HR data with LR data. As illustrated in in FIG. 3, program code executing on one or more processors obtains a low-resolution image (input) (310). The program code applies a 2D convolutional filter to learn a horizontal spatial structure of the input and generates a representation of the spatial structure, which transforms physical space information to model-space information (320). The program code replicates the representation three times (Q, K, V) to calculate self-attention computation (330). Q, K, and V are utilized in deep learning architectures (e.g., transformers), they can represent a three-vector query (Q), a key (K) and a value (V). At each horizontal pixel, the program code calculates a dot product between Q and K matrixes to compute self-attention (340). Hence, in the self-attention computation the program code computes information mixing in the vertical direction. Thus, the program code commences with a horizontal operation, moves to a vertical operation, and then generates a self-attention map. The self-attention may (generating based on iterations of the preceding processes), is provided to another convolutional filter to generate (upscale) to HR output. In some examples, the program code repeats the self-attention computation a few times to generate the self attention map that the program code utilizes to generate an HR output (350).

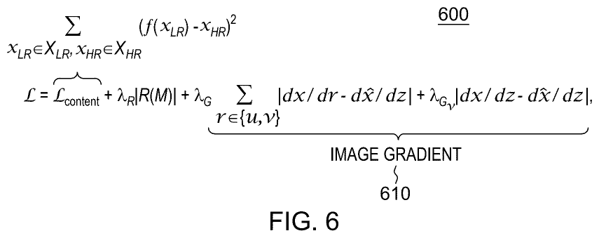

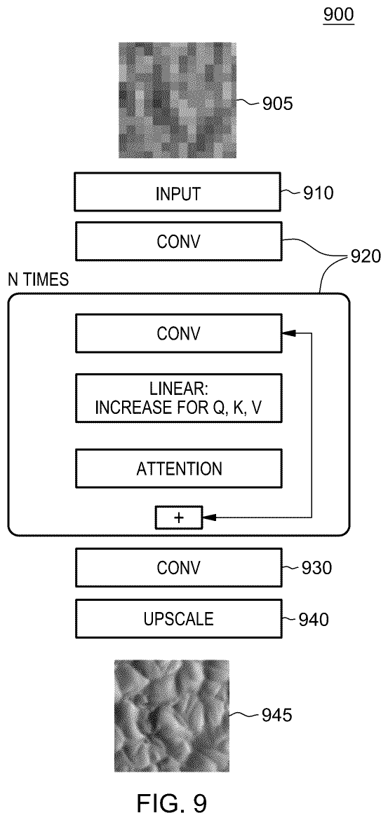

FIG. 9 provides a broad overview workflow 900 of aspects of the workflow 300 of FIG. 3. The workflow 900 of FIG. 9 starts with program code taking a low resolution image 905 as input (910). The program code then applies the 2D convolutional filter portion which can be repeated N times (920). In this portion of the workflow 900, the program code applied a CNN in two dimensions for each horizontal layer. By applying the CNN to each horizontal layer, the program code converts these data from a physical space and a physical representation to a model space. As illustrated in FIG. 6, this aspect includes the program code applying a 2D convolutional filter to learn a horizontal spatial structure of the input and generating a representation of the spatial structure, which transforms physical space information to model-space information. As noted above, the program code replicates the representation three times (Q, K, V) to calculate self-attention computation. At each horizontal pixel, the program code calculates a dot product between Q and K matrixes to compute self-attention. Hence, the horizontal operation is followed by a vertical operation (replicating the representation three times (Q, K, V) to calculate self-attention computation). So, the self-attention computation computes model-space information at vertical directions. The results of applying the 2D convolutional filter is a self-attention map. The program code provides the self-attention map (e.g., after it has been regularized) to a convolutional filter (930). The convolutional filter upscales the self-attention map (940) to generate an HR image 945 (a high resolution version of the inputted low resolution image 905). FIG. 9 demonstrates that there is an encoding phase in the workflow 900, generating a self-attention map from a low resolution image 905, and a decoding phase, generating an HR image 945 from the self-attention map.

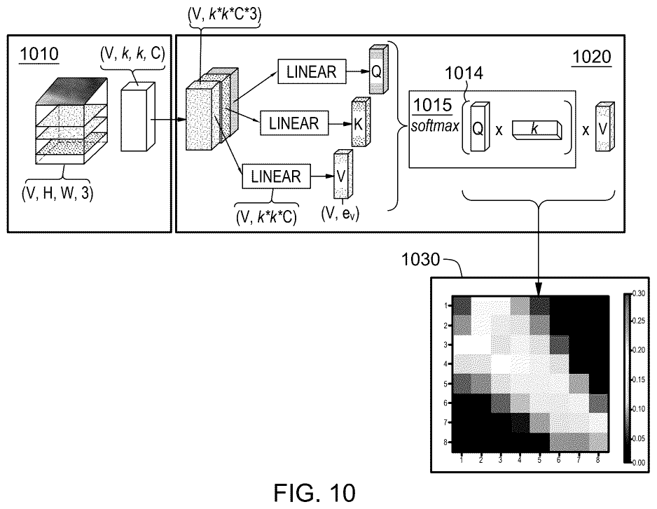

FIG. 10 illustrated various aspects of the workflows of FIGS. 3 and 9, namely, the horizontal operation (executed by the program code), the vertical operation (executed by the program code) and generating a self-attention map (by the program code). FIG. 10 illustrates the horizontal aspect 1010, the vertical aspect 1020 and the self-attention map 1030 generated at the conclusion of the vertical aspect 1020. The horizontal aspect includes learning the spatial structure of the low resolution image by applying a two dimensional convolutional filter, and generating a representation. In the vertical aspect 1020, the program code replicates the representation (from the horizontal aspect 1010) three times Q, K, V and the program code calculates a self-attention map (using a self-attention computation 1025). The calculations and transformations for the “V” vector are provided in the figure. At each pixel, the program code calculates a dot product between Q and K matrixes, transforming physical space information to model-space information to compute the self-attention map 1030. The program code computes, in the self attention computation 1025, model-space information at vertical directions, to generate the self-attention map 1030. The softmax function is used to illustrate that the self attention computation 1025 is a final layer of a neural network model for classification tasks (e.g., the two-dimensional CNN).

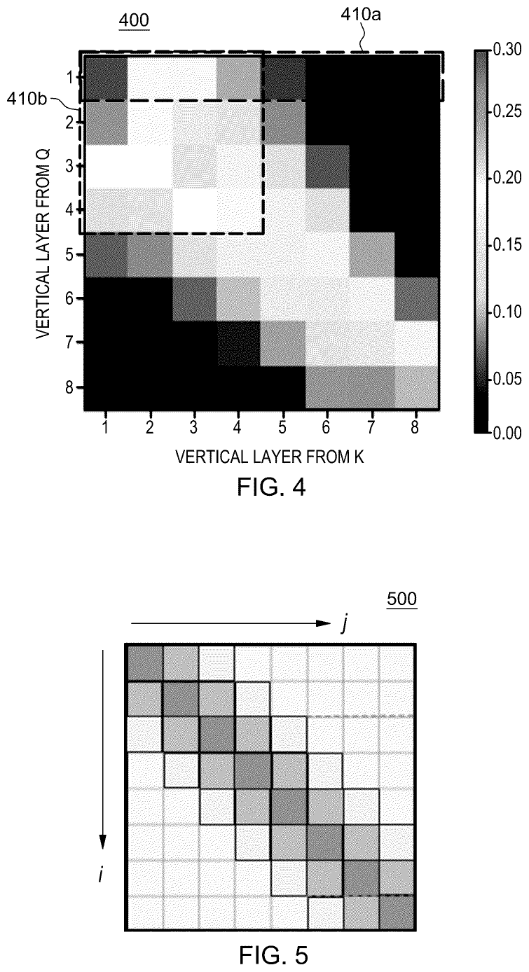

Returning to FIG. 4, the self-attention map 400, output in the workflow of FIG. 300 is provided as FIG. 4. The self-attention map 400, generated by the program code in the examples herein, is a matrix. The matrix represents that at each row the 8 column elements tell a probability of influence between a layer at a row against all layers from columns. Thus, the sum of value at each row is 1. The rectangles 410a-410b illustrate how data from first layer from Q matrix and data from all columns each of which is one of 8 layers from K matrix associated with each other. One rectangle 410a shows an association of layer-1 and all 8 layers. In this examples, the diagonal elements have relatively larger values and the top left corners have relatively higher values at wider areas. Hence, the self-attention map generated by the program code captures that there are convections happening at the bottom of atmosphere in daytime, which corresponds to the real-world dynamics. As illustrated in FIG. 8, the program code utilizes this map to generate the HR image.

The results of the model can be tuned by the program code providing additional attention by adding a regularization term that amplifies strong signals and reduces weak signals from the self-attention map. Hence, regularizing “self-attention” amplifies or reduces signals. The program code can apply a penalty term R(M) to amplify strong signals so that they are stronger and reduces weak signals so that they are weaker and to highlight key elements in the self-attention matrix M. Thus, the most important data is preserved when the program code generates the HR image. FIG. 5 illustrates a self-attention map 500 with dimensions i and j. Below is a calculation where the model is tuned utilizing the penalty term R, the matrix M, the dimensions of the matrix, i and j and a softmax function. A softmax function is a normalized exponential function that converts a vector of K real numbers into a probability distribution of K possible outcomes. The softmax function is often used as the last activation function of a neural network to normalize the output of a network to a probability distribution over predicted output classes. Equations 1, 2, and 3 illustrated the derivations of the matric (Equation 1), the logic of the penalty (Equation 2), and applying the penalty to the matrix (Equation 3).

$$\begin{matrix}{M}_{ij} = softmax ( {QK}^{T} / \sqrt{{e}_{v}} ) , \\ {R}_{i} = {\sum }_{j = 1}^{V} {M}_{ij}^{2} , \\ R ( M ) = {\sum }_{i = 1}^{V} \frac{1}{{R}_{i}} .\end{matrix} \qquad ( Equations 1 , 2 , and 3 )$$

The input into the model trained and generated in the examples herein is a low-resolution image, x_{LR}, and the output is a high-resolution ground truth image, x_{HR}. A ground truth image refers to a high-resolution image that serves as a reference for evaluating reconstruction algorithms by computing a loss function.

In order to obtain LR data and reconstruct HR data from it, the program code of the network (NN) performing this transformation and hence, utilized in the examples herein is trained with a minimized loss function. The loss function consists of a reconstruction error (L content), the regularization in Equations 1-3 and an additional regularization on the gradient of images. In the last term of the loss function, the program code computes a gradient of the images and computes a difference between a predicted gradient and the true gradient and gives the information to regularize the behavior of the NN. This computation 600 is provided as FIG. 6. The portion of the function that is the image gradient 610 is indicated in FIG. 6. In FIG. 6, the loss function, [symbol] _{content}, computes the difference between the reconstruction from the low resolution data, ƒ(x_{LR}), and the high-resolution ground truth data (x_{HR}) and λ_{R}, λ_{G}, and λ_{G}_{ᵥ} are user specified parameters, which controls the relative importances of sparsifying the attention map, matching the horizontal gradients of the velocity components, and matching the vertical gradient of the velocity, respectively.

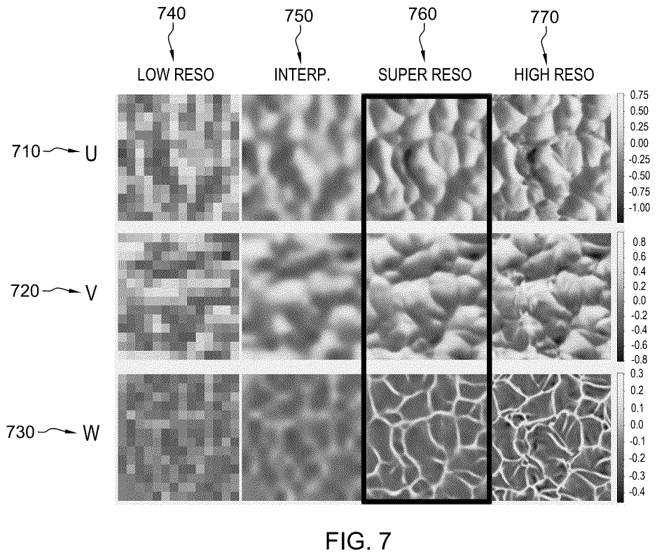

FIG. 7 illustrates a contrast between images of different resolutions that represent wind fields. U 710, V 720, and W 730 represent the three components of wind velocity, where “U” indicates the east-west wind component (positive value means blowing eastward), “V” represents the north-south wind component (positive value means blowing northward), and “W” represents the vertical wind component (positive value means upward movement). Hence, the rows are three dimension of wind components. The approach described herein, which can be understood as a super-resolution approach, can generate high-fidelity images. Super-resolution is a technique in computer vision and physical sciences but applying it in the absence of others aspects of the examples herein does not provide the same quality of output. In some existing wind-data super-physics application, one can upscale fifty times but will be limited to a 2D result. Meanwhile, a turbulence simulation application can incorporate 3D and time components but because these approaches are both based on CNNs, the ability of the model to learn 3D physics is limited (as demonstrated earlier).

FIG. 7 illustrates the quality of the results generated utilizing the examples described herein when compared to other approaches. FIG. 7 illustrates from left to right: an LR input 740, results of interpolation of the input 750, results of applying the model generated and trained herein to the LR input (super resolution images) 760, and the high-resolution ground truth 770. FIG. 7 demonstrates how the model trained and applied herein produces realistic wind fields. In this example, the average mean square error for interpolation is 1.86e-2 and for the application of the aspects described herein, the mean square error average is 1.09e-2. These examples are provided for illustrative purposes only.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described to best explain various aspects and the practical application, and to enable others of ordinary skill in the art to understand various embodiments with various modifications as are suited to the particular use contemplated.

What is claimed is:

1. A computer-implemented method for reconstructing a high-resolution image from a low-resolution image, comprising:
obtaining, by one or more processors, low-resolution data comprising the low-resolution image;
applying, by the one or more processors, to the low-resolution data, a two-dimensional convolutional filter, wherein the applying comprises:
automatically learning, by the one or more processors, a spatial structure of the low-resolution data;
generating, by the one or more processors, a representation of the spatial structure of the low-resolution data;
transforming, by the one or more processors, physical space information to model-space information;
replicating, by the one or more processors, the representation to generate additional representations that coordinate with vectors; and
generating, by the one or more processors, a self-attention map by calculating a dot product between certain of the additional representations to learn vertical mixing of information; and
applying, by the one or more processors, a penalty term to the self-attention map, wherein the applying modified data comprising the self-attention map by amplifying strong signals and reducing weak signals.

2. The computer-implemented method of claim 1, further comprising:
applying, by the one or more processors, a neural network to the self-attention map to generate the high-resolution image by utilizing the additional representations and the self-attention map.

3. The computer-implemented method of claim 1, wherein the additional representations comprise a first representation, a second representation, and a third representation based on replicating the representation three times based on three vectors.

4. The computer-implemented method of claim 3, wherein the dot product comprises a product of the first representation and the second representation.

5. The computer-implemented method of claim 4, wherein the three vectors comprise a query (Q) vector, a key (K) vector, and a value (V) vector.

6. The computer-implemented method of claim 4, wherein the first representation comprises a query (Q) representation, and the second representation comprises a key (K) representation.

7. The computer-implemented method of claim 1, wherein applying the two-dimensional convolutional filter and replicating the representation comprises generating a layered representation of the low-resolution data.

8. The computer-implemented method of claim 7, wherein each layer of the layered representation of the low-resolution data comprises a layer of a given height.

9. The computer-implemented method of claim 8, wherein the given height is selected from the group consisting of: a pre-defined height or a height selected based on an expected outcome to capture dynamics.

10. The computer-implemented method of claim 7, wherein transforming the physical space information to model-space information to applying a self-attention model at each pixel of the layered representation.

11. The computer-implemented method of claim 7, further comprising learning dynamics in a vertical direction from the layered representation.

12. The computer-implemented method of claim 2, wherein the neural network is a trained neural network.

13. The computer-implemented method of claim 9, further comprising:
training, by the one or more processors, the neural network, wherein the training comprises minimizing a loss function to regularize behavior of the neural network.

14. The computer-implemented method of claim 1, wherein the high-resolution image comprises a super-resolution image.

15. A computer system for reconstructing a high-resolution image from a low-resolution image, comprising:
a memory; and
one or more processors in communication with the memory, wherein the computer system is configured to perform a method, said method comprising:
obtaining, by the one or more processors, low-resolution data comprising the low-resolution image;
applying, by the one or more processors, to the low-resolution data, a two-dimensional convolutional filter, wherein the applying comprises:
automatically learning, by the one or more processors, a spatial structure of the low-resolution data;
generating, by the one or more processors, a representation of the spatial structure of the low-resolution data;
transforming, by the one or more processors, physical space information to model-space information;
replicating, by the one or more processors, the representation to generate additional representations that coordinate with vectors; and
generating, by the one or more processors, a self-attention map by calculating a dot product between certain of the additional representations to learn vertical mixing of information; and
applying, by the one or more processors, a penalty term to the self-attention map, wherein the applying modified data comprising the self-attention map by amplifying strong signals and reducing weak signals.

16. The computer system of claim 15, further comprising:
applying, by the one or more processors, a neural network to the self-attention map to generate the high-resolution image by utilizing the additional representations and the self-attention map.

17. The computer system of claim 16, wherein the additional representations comprise a first representation, a second representation, and a third representation based on replicating the representation three times based on three vectors.

18. The computer system of claim 17, wherein the dot product comprises a product of the first representation and the second representation.

19. A computer program product for reconstructing a high-resolution image from a low-resolution image, the computer program product comprising:
one or more computer readable storage media and program instructions collectively stored on the one or more computer readable storage media readable by at least one processing circuit to:
obtain low-resolution data comprising the low-resolution image;
apply, to the low-resolution data, a two-dimensional convolutional filter, comprising:
automatically learning a spatial structure of the low-resolution data;
generating a representation of the spatial structure of the low-resolution data;
transforming physical space information to model-space information;
replicating the representation to generate additional representations that coordinate with vectors; and
generating a self-attention map by calculating a dot product between certain of the additional representations to learn vertical mixing of information; and
apply a penalty term to the self-attention map, wherein the applying modified data comprising the self-attention map by amplifying strong signals and reducing weak signals.

20. The computer program product of claim 19, further comprising additional program instructions to:
apply a neural network to the self-attention map to generate the high-resolution image by utilizing the additional representations and the self-attention map.
